(19) United States
(12) Patent Application Publication
(10) Pub. No.: US 2006/0055660 A1
(43) Pub. Date: Mar. 16, 2006

(54) Light source device

(76) Inventor: Kentaro Teranishi, Kanazawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/220,847

(22) Filed: Sep. 8, 2005

(30) Foreign Application Priority Data
Sep. 13, 2004 (JP) 2004-265640

(51) Int. Cl. G09G 3/36

(52) U.S. Cl. 345/102

(57) ABSTRACT

A light source device includes lamp-type light sources which respectively illuminate display areas obtained by dividing a screen of a display panel, and a backlight drive circuit which drives the lamp-type light sources. Particularly, the backlight drive circuit includes a dimmer control circuit which generates dimmer control signals having a common duty ratio which is changed to define ON time for each preset period of time and being set to different phases, and driving units which respectively drive the lamp-type light sources according to the dimmer control signals generated from the dimmer control circuit.

### CROSS-REFERENCE TO RELATED APPLICATIONS

This application is based upon and claims the benefit of priority from prior Japanese Patent Application No. 2004-265640, filed Sep. 13, 2004, the entire contents of which are incorporated herein by reference.

### BACKGROUND OF THE INVENTION

1. Field of the Invention

This invention relates to a light source device which is applied to a liquid crystal display panel of an OCB (Optically Compensated Birefringence) mode, for example.

2. Description of the Related Art

A flat display device, represented by a liquid crystal display device, is widely used as a display device for a computer, car navigation system or television receiver.

The liquid crystal display device generally has a liquid crystal display panel containing a matrix array of liquid crystal pixels and a display panel control circuit which controls the display panel. The liquid crystal display panel has a structure in which a liquid crystal layer is held between an array substrate and a counter substrate.

The array substrate has a plurality of pixel electrodes arrayed in substantially a matrix form, a plurality of gate lines arranged along rows of pixel electrodes, a plurality of source lines arranged along columns of pixel electrodes, and a plurality of switching elements arranged near the intersections between the gate lines and the source lines. Each switching element includes a thin-film transistor (TFT), for example, and is made conductive to supply a potential of one source line to one pixel electrode when one gate line is driven. On the counter substrate, a common-electrode is provided to face the pixel electrodes arrayed on the array substrate. A pair of the pixel electrode and the common electrode forms a pixel together with a pixel area of the liquid crystal layer and controls the alignment state of liquid crystal molecules in the pixel area by an electric field between the pixel electrode and the common electrode. The display panel control circuit has a gate driver which drives the gate lines, a source driver which drives the source lines, and a controller which controls operation timings of the gate driver and source driver.

In a case where the liquid crystal display device is used for a television receiver which mainly displays a moving image, an OCB-mode liquid crystal display panel, in which liquid crystal molecules indicate a preferable response, is generally used (refer to Jpn. Pat. Appln. KOKAI Publication No. 2002-202491). In the liquid crystal display panel, the liquid crystal molecules are aligned in a splay alignment before supply of power. This splay alignment is a state where the liquid crystal molecules are laying flat, and obtained by alignment films which are disposed on the pixel electrode and the counter electrode and rubbed in parallel with each other. The liquid crystal display panel performs an initializing process upon supply of power. In this process, a relatively strong electric field is applied to the liquid crystal molecules to transfer the splay alignment to a bend alignment. A display operation is performed after the initializing process.

The reason why the liquid crystal molecules are aligned in the splay alignment before supply of power is that the splay alignment is more stable than the bend alignment in terms of energy in a state where the liquid crystal driving voltage is not applied. As a characteristic of the liquid crystal molecules, the bend alignment tends to be inverse-transferred to the splay alignment if a state where no voltage is applied or a state where a voltage lower than a level at which the energy of splay alignment is balanced with the energy of bend alignment is applied, is sustained for a long time. The viewing angle characteristic of the splay alignment significantly differs from that of the bend alignment. Thus, a normal display is not attained in this splay alignment.

In a conventional driving method that prevents the inverse transfer from the bend alignment to the splay alignment, a high voltage is applied to the liquid crystal molecules in a part of a frame period for a display of a 1-frame image, for example. This high voltage corresponds to a pixel voltage for a black display in an OCB-mode liquid crystal display panel, which is a normally-white type, so this driving method is called “black insertion driving.”

An entire screen of the liquid crystal display panel is illuminated by a backlight using a single lamp-type light source which is normally a cold cathode fluorescent tube. The brightness of the screen can be controlled by changing the rate of ON time for each preset period of time. The backlight drive circuit generates a dimmer control signal having a duty ratio corresponding to an external pulse-width modulation (PWM) dimmer signal, for example, converts the dimmer control signal to a drive voltage and supplies the drive voltage to the lamp-type light source. In this case, the lamp-type light source is turned ON and OFF according to the duty ratio of the PWM dimmer signal.

However, if the PWM dimmer signal of a relatively low frequency is used in a dimmer control for the brightness of the screen, flicker becomes prominent. The flicker can be suppressed by an increase in the frequency of the PWM dimmer signal. In this case, however, there occurs a problem that the lamp-type light source incompletely turns on when the ON time becomes extremely short. Further, when the display panel is configured using OCB liquid crystal pixels that require the black insertion driving, it is difficult to control the brightness as desired since the brightness is influenced by a black insertion driving operation performed during the ON time of the lamp-type light source or an image display operation performed during the OFF time of the lamp-type light source. Thus, failure in the dimmer control easily occurs.

### BRIEF SUMMARY OF THE INVENTION

An object of this invention is to provide a light source device which can prevent flicker from becoming prominent in the dimmer control.

According to an aspect of the present invention, there is provided a light source device which comprises a plurality of lamp-type light sources which respectively illuminate display areas obtained by dividing a screen of a display panel, and a light source driving circuit which drives the lamp-type light sources, wherein the light source driving circuit includes a dimmer control circuit which generates dimmer control signals having a common duty ratio which is changed to define an ON time for each preset period of time, and being set to different phases, and a plurality of driving units which respectively drive the lamp-type light sources according to the dimmer control signals generated from the dimmer control circuit.

In the above light source device, since the duty ratios of the dimmer control signals are equal, the average luminance levels of the lamp-type light sources become the same. In addition, since the phases of the dimmer control signals are different, all of the lamp-type light sources can be prevented from being set into an ON state or OFF state, except a case wherein the brightness of the screen is set to 100% or 0%. That is, since brightness is changed for each display area by the dimmer control, flicker can be prevented from being prominent in comparison with a case wherein brightness is changed for the entire screen. Therefore, it becomes unnecessary to repeatedly turn ON and OFF the lamp-type light source at a high frequency. Further, since an area of the brightness change caused by the dimmer control is dispersed in the screen, it is possible to reduce the failure caused in the dimmer control when the screen of the display panel is formed of OCB liquid crystal pixels that require the black insertion driving.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing the circuit configuration of a liquid crystal display device according to one embodiment of this invention;

FIG. 2 is a view showing the relationship between a backlight and a display panel shown in FIG. 1;

FIG. 3 is a diagram showing the circuit configuration of a light source device shown in FIG. 1 in more detail;

FIG. 4 is a diagram for illustrating the operation which is performed by the light source device shown in FIG. 3 to reduce the brightness of the entire screen to ⅔ thereof;

FIG. 5 is a diagram for illustrating the operation which is performed by the light source device shown in FIG. 3 to reduce the brightness of the entire screen to ½ thereof;

FIG. 6 is a diagram for illustrating the operation which is performed by the light source device shown in FIG. 3 to reduce the brightness of the entire screen to ⅔ thereof with a use of lamp-type light sources arranged at uneven pitches; and

FIG. 7 is a diagram showing one example of the operation when the number of lamp-type light sources serving as the backlight shown in FIG. 3 is increased.

### DETAILED DESCRIPTION OF THE INVENTION

There will now be described a liquid crystal display device according to one embodiment of this invention with reference to the accompanying drawings.

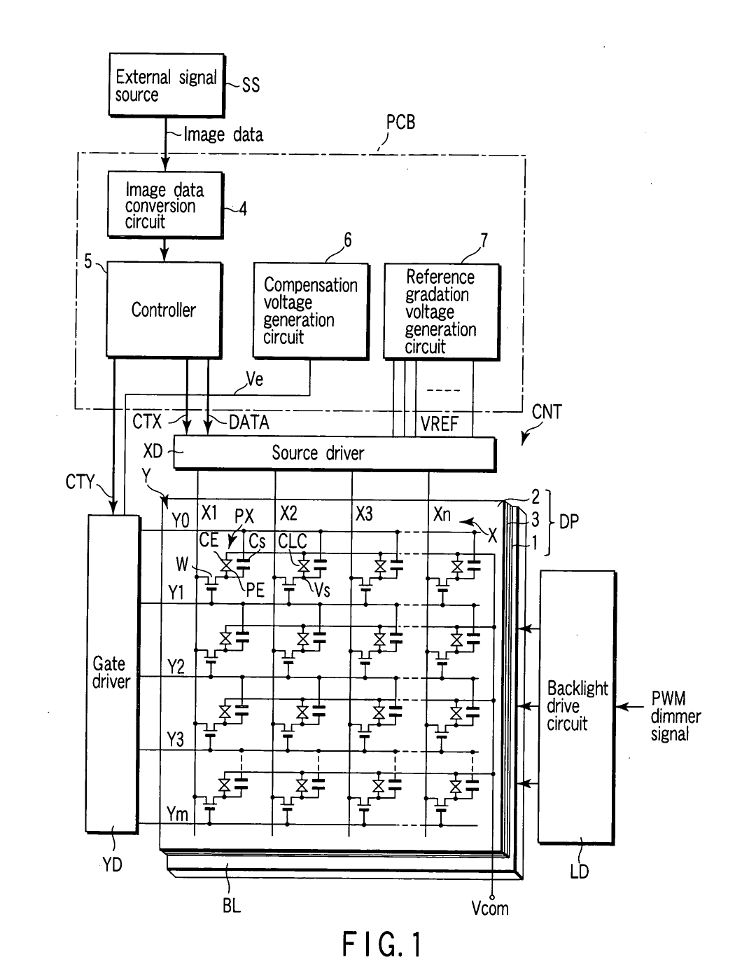

FIG. 1 schematically shows the circuit configuration of the liquid crystal display device. The liquid crystal display device includes a liquid crystal display panel DP, a display panel control circuit CNT connected to the display panel DP, a backlight BL which illuminates the display panel DP, and a backlight drive circuit LD which drives the backlight BL. The liquid crystal display panel DP has a structure in which a liquid crystal layer 3 is held between an array substrate 1 and a counter substrate 2 which are a pair of electrode substrates. For example, the liquid crystal layer 3 contains a liquid crystal material whose liquid crystal molecules are transferred in advance from a splay alignment to a bend alignment usable for a normally-white display, and are prevented from being inverse-transferred from the bend alignment to the splay alignment by a voltage for black insertion that is cyclically applied. The display panel control circuit CNT controls the transmittance of the liquid crystal display panel DP by a liquid crystal driving voltage that is applied from the array substrate 1 and counter electrode 2 to the liquid crystal layer 3. The display panel control circuit CNT performs a predetermined initializing process upon supply of power. The splay alignment is transferred to the bend alignment by a relatively strong electric field applied to the liquid crystal layer 3 in the initializing process. The backlight BL and backlight drive circuit LD configure a light source device.

The array substrate 1 includes a plurality of pixel electrodes PE arrayed substantially in a matrix form on a transparent insulating substrate such as a glass plate, a plurality of gate lines Y (Y0 to Ym) arranged along the rows of pixel electrodes PE, a plurality of source lines X (X1 to Xn) arranged along the columns of pixel electrodes PE, and a plurality of pixel switching elements W arranged near the intersections between the gate lines Y and the source lines X, each pixel switching element being made conductive between a corresponding one of the source lines X and a corresponding one of the pixel electrodes PE when it is driven via a corresponding one of the gate lines Y. Further, each pixel switching element W is formed of a thin film transistor, for example, the gate of the thin film transistor is connected to the gate line Y and the source-drain path thereof is connected between the source line X and the pixel electrode PE.

The counter substrate 2 includes a color filter arranged on a transparent insulating substrate such as a glass plate, and a common electrode CE arranged on the color filter so as to be opposed to the pixel electrodes PE. Each pixel electrode PE and common electrode CE are formed of a transparent electrode material such as ITO, and are coated with alignment films that are subjected to rubbing treatment in directions parallel to each other. To form a pixel PX, each pixel electrode PE and the common electrode CE are associated with a pixel area of the liquid crystal layer 3 which is controlled to have a liquid crystal alignment corresponding to an electric field applied from the pixel electrode PE and common electrode CE.

Each of the pixels PX includes a liquid crystal capacitance CLC between the pixel electrode PE and the common electrode CE and is connected to one end of a storage capacitance Cs. Each storage capacitance Cs is formed by capacitive coupling between the pixel electrode PE of the pixel PX and the preceding-stage gate line Y which controls the pixel switching element W of the pixel PX which is adjacent to one side of the above pixel PX. The storage capacitance Cs has a sufficiently large capacitance value in comparison with the parasitic capacitance of the pixel switching element W. FIG. 1 omits depiction of a plurality of dummy pixels disposed around the matrix array of the pixels PX which serves as the display screen. The dummy pixels are wired in the same manner as the pixels PX in the display screen. The dummy pixels are provided in order to make equal the conditions, such as parasitic capacitances, for all the pixels PX within the display screen. The gate line Y0 is a gate line for the dummy pixels.

The display panel control circuit CNT includes a gate driver YD that drives the gate lines Y0 to Ym so as to turn on the switching elements W on a row-by-row basis; a source driver XD that outputs pixel voltages Vs to the source lines X1 to Xn in a time period in which the switching elements W on each row are driven by the associated gate line Y; an image data converting circuit 4 which makes the conversion of gradation, resolution and the like with respect to image data configured by items of pixel data input for the pixels PX from an external signal source SS in each frame period (vertical scanning period), and a controller 5 which controls the operation timing and the like of the gate driver YD and source driver XD with respect to image data obtained as the result of conversion by the image data conversion circuit 4. The pixel voltage Vs is applied to the pixel electrode PE with common voltage Vcom of the common electrode CE used as a reference and, for example, the polarity thereof is inverted with respect to the common voltage Vcom to perform a combination of the frame inversion driving operation and line inversion driving operation.

For example, the gate driver YD and source driver XD are formed of integrated circuit (IC) chips mounted on flexible wiring sheets arranged along the outer periphery of the array substrate 1. The image data conversion circuit 4 and controller 5 are disposed on an external printed circuit board PCB. The controller 5 generates control signals CTY and CTX, for example. The control signal CTY is used to sequentially drive the gate lines Y, as described above. The control signal CTX is used to allocate pixel data items DATA, which are obtained for each row of pixels PX as the result of conversion by the image data conversion circuit 4 and serially output, to the source lines X and specify the output polarity. The control signal CTY is supplied from the controller 5 to the gate driver YD and the control signal CTX is supplied from the controller 5 to the source driver XD together with the pixel data DATA obtained as the result of conversion from the pixel data conversion circuit 4.

The display panel control circuit CNT further includes a compensation voltage generation circuit 6 which generates compensation voltage Ve applied to the preceding-stage gate line Y adjacent to one side of the gate line Y which is connected to the switching elements W when the switching elements W of one row are made non-conductive via the gate driver YD, and is used to compensate for a variation in the pixel voltage Vs occurring in the pixels PX of one row by parasitic capacitors associated with the switching elements W, and a reference gradation voltage generation circuit 7 which generates a preset number of reference gradation voltages VREF used to convert the image data DATA to pixel voltage Vs.

The gate driver YD sequentially selects the gate lines Y1 to Ym in one frame period under control by the control signal CTY and supplies ON voltage which makes the switching elements W of each row conductive in one horizontal scanning period to the selected gate line Y. The image data conversion circuit 4 outputs the conversion result configured by the pixel data DATA for the pixels PX of one row for each horizontal scanning period. Further, the source driver XD converts the pixel data items DATA to pixel voltages Vs by referring to a preset number of reference gradation voltages VREF supplied from the reference gradation voltage generation circuit 7 and outputs the thus obtained converted voltages to the source lines X1 to Xn in parallel.

For example, if the gate driver YD drives the gate line Y1 by use of ON voltage and makes all of the pixel switching elements W connected to the gate line Y1 conductive, pixel voltages Vs on the source lines X1 to Xn are supplied to the corresponding pixel electrodes PE and one-side ends of the storage capacitances Cs via the pixel switching elements W. Further, the gate driver YD outputs the compensation voltage Ve from the compensation voltage generation circuit 6 to the preceding-stage gate line Y0 which is adjacent to the gate line Y1 to make conductive all of the switching elements W which are connected to the gate line Y1 in one horizontal scanning period and, immediately after this, outputs OFF voltage which is used to make the pixel switching elements W nonconductive to the gate line Y1. The compensation voltage Ve reduces an amount of charges leaked from the pixel electrodes PE due to the parasitic capacitances of the pixel switching elements W to substantially cancel a variation in the pixel voltages Vs, that is, field-through voltage ΔVp when the pixel switching elements W are made nonconductive.

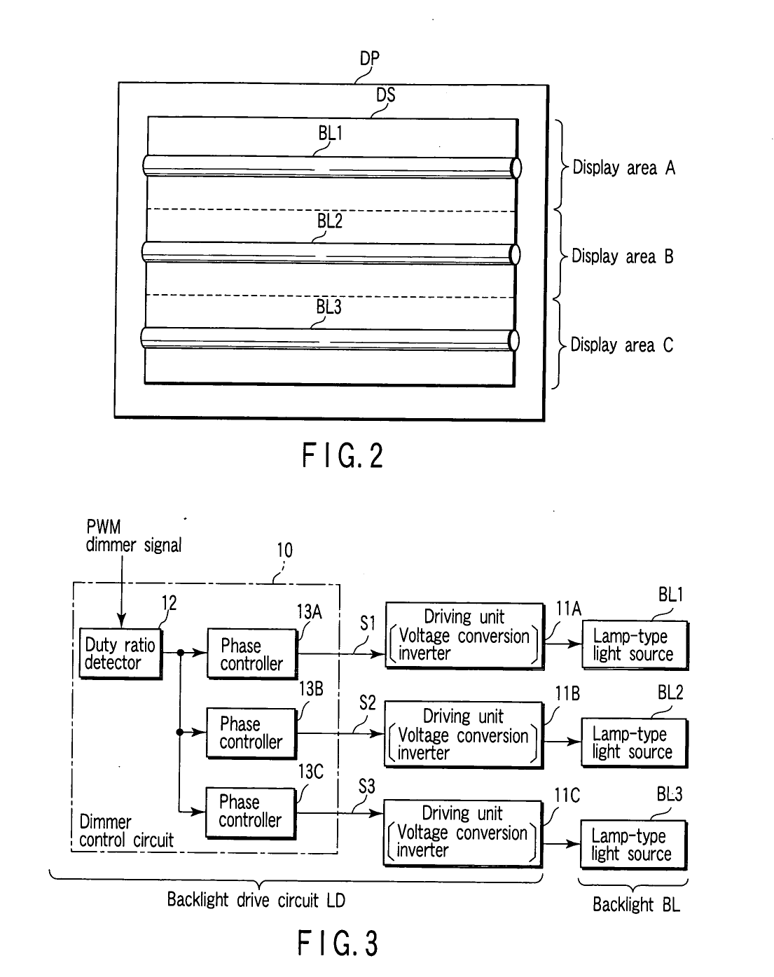

FIG. 2 shows the relationship between the backlight BL and the display panel DP shown in FIG. 1. A display screen DS shown in FIG. 2 is configured by OCB liquid crystal pixels PX arrayed in a matrix form. For example, the backlight BL contains three lamp-type light sources BL1, BL2 and BL3 which mainly illuminate a plurality of display areas A, B, C obtained by equally dividing the display screen DS in a vertical direction. Each of the lamp-type light sources BL1, BL2 and BL3 is configured to contain one cold cathode fluorescent tube. The cold cathode fluorescent tubes of the lamp-type light sources BL1, BL2 and BL3 are arranged in parallel at preset pitches on the rear surface of the display panel DP.

FIG. 3 shows the circuit configuration of the light source device shown in FIG. 1 in more detail. For example, the backlight drive circuit LD includes a dimmer control circuit 10 and driving units 11A, 11B, 11C. The dimmer control circuit 10 generates dimmer control signals S1, S2, S3 having a common duty ratio which is changed to define an ON time for each preset period of time such as each vertical scanning period (1V), and being set to different phases. The driving units 11A, 11B, 11C respectively drive the lamp-type light sources BL1, BL2, BL3 according to the dimmer control signals S1, S2, S3 from the dimmer control circuit 10.

The dimmer control circuit 10 includes a duty ratio detector 12 which detects the duty ratio of a PWM dimmer signal supplied from the exterior by the user and outputs a pulse width modulation signal having the same frequency as that of the PWM dimmer signal at a duty ratio corresponding to the result of detection. Further, it includes phase controllers 13A, 13B, 13C which change the phase of pulse width modulation signal output from the duty ratio detector 12 to respectively output dimmer control signals S1, S2, S3. In this case, the dimmer signals S1, S2, S3 are set to a frequency in which one vertical scanning period (1V) is set to one period, for example. Each of the driving units 11A, 11B, 11C is configured as a voltage conversion inverter which converts a dimmer signal from a corresponding one of the phase controllers 13A, 13B, 13C to drive voltage for a corresponding one of the lamp-type light sources BL1, BL2, BL3.

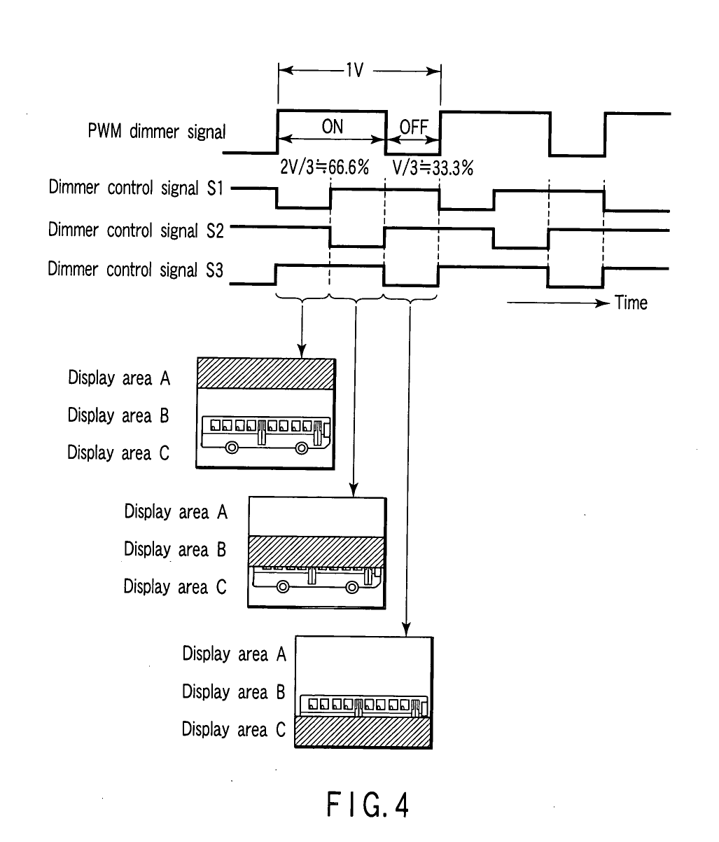

FIG. 4 shows the operation of the light source device which reduces the brightness of the entire display screen DS to ⅔ thereof. As shown in FIG. 4, the PWM dimmer signal is set at a high level for ON time for a 2V/3 period and at a low level for OFF time for a 1V/3 period. If the duty ratio detector 12 outputs a pulse width modulation signal having the same frequency as that of the PWM dimmer signal at the above duty ratio, then the phase controller 13A outputs a dimmer control signal S1 obtained by, for example, delaying the phase of the pulse width modulation signal by a 1V/3 period, the phase controller 13B outputs a dimmer control signal S2 obtained by, for example, delaying the phase of the pulse width modulation signal by a 2V/3 period and the phase controller 13C outputs a dimmer control signal S3 obtained by, for example, delaying the phase of the pulse width modulation signal by a 3V/3 period or 1V period. The driving units 11A, 11B, 11C respectively convert the dimmer control signals S1, S2, S3 to drive voltages based on an inverter system and output the thus converted drive voltages to the lamp-type light sources BL1, BL2, BL3. The lamp-type light sources BL1, BL2, BL3 are turned ON and OFF at the duty ratios maintained in the respective drive voltages. Therefore, the states of the display areas A, B, C are shifted by 1V/3 from one another as shown in FIG. 4.

FIG. 5 shows the operation of the light source device which reduces the brightness of the entire display screen DS to ½ thereof. As shown in FIG. 5, the PWM dimmer signal is set at a high level for ON time for a 1V/2 period and at a low level for OFF time for a 1V/2 period. If the duty ratio detector 12 outputs a pulse width modulation signal having the same frequency as that of the PWM dimmer signal at the above duty ratio, then the phase controller 13A outputs a dimmer control signal S1 obtained by, for example, delaying the phase of the pulse width modulation signal by a 1V/3 period, the phase controller 13B outputs a dimmer control signal S2 obtained by, for example, delaying the phase of the pulse width modulation signal by a 2V/3 period and the phase controller 13C outputs a dimmer control signal S3 obtained by, for example, delaying the phase of the pulse width modulation signal by a 3V/3 period or 1V period. The driving units 11A, 11B, 11C respectively convert the dimmer control signals S1, S2, S3 to drive voltages based on an inverter system and output the thus converted drive voltages to the lamp-type light sources BL1, BL2, BL3. The lamp-type light sources BL1, BL2, BL3 are turned ON and OFF at the duty ratios maintained in the respective drive voltages. Therefore, the states of the display areas A, B, C are shifted by 1V/6 from one another as shown in FIG. 5.

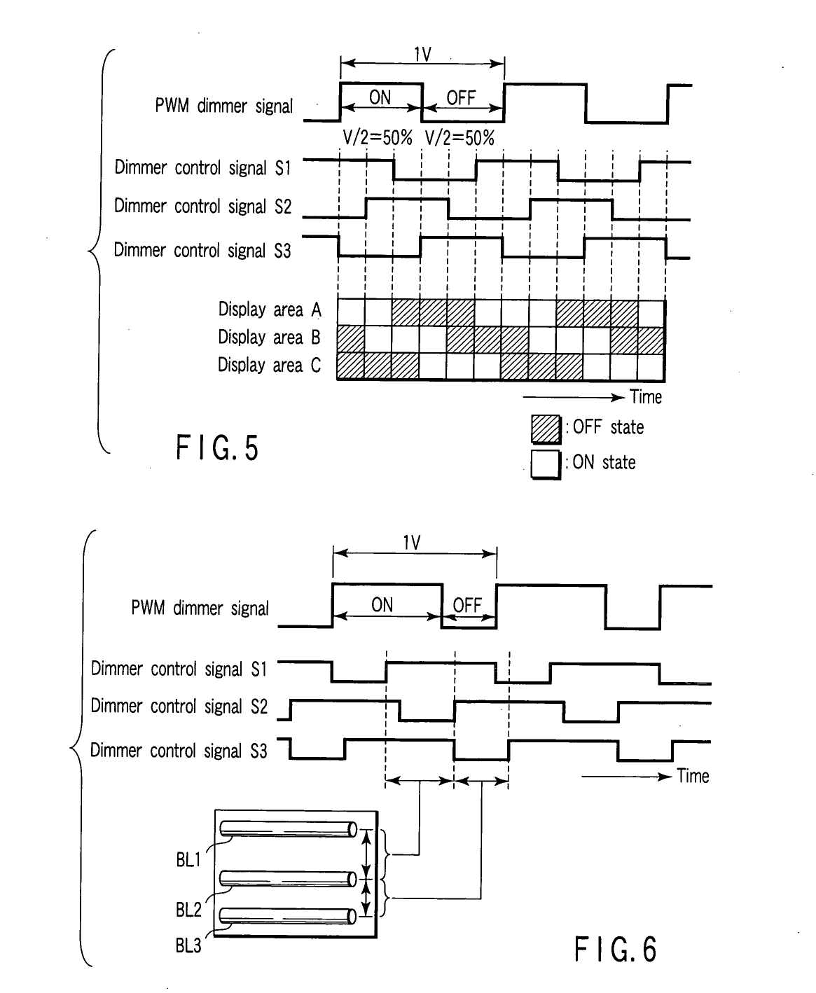

In the above example, all of the phase differences between the dimmer control signals S1, S2, S3 are set to 1V/3, but another value can be used as a reference. Further, when the pitches of the lamp-type light sources BL1, BL2, BL3 are uneven, it is preferable to determine the phase differences between the dimmer control signals S1, S2, S3 based on the distances between the lamp-type light sources BL1, BL2, BL3 as shown in FIG. 6, for example.

In the liquid crystal display device of the present embodiment, since the duty ratios of the dimmer control signals S1, S2, S3 are equal, the average illumination levels of the lamp-type light sources BL1, BL2, BL3 are set to the same level. In addition, since the phases of the dimmer control signals S1, S2, S3 are different from one another, all of the lamp-type light sources can be prevented from being set to the ON state or OFF state except a case wherein the brightness of the display screen DS is set to 100% or 0%. That is, since brightness is changed for each display area by the dimmer control, flicker can be made non-prominent in comparison with a case wherein brightness is changed for the entire display screen. Therefore, it becomes unnecessary to repeatedly turn ON and OFF the lamp-type light sources BL1, BL2, BL3 at a high frequency. Further, since an area of the brightness change by the dimmer control is dispersed, it is possible to reduce the failure caused in the dimmer control when the screen of the display panel is formed of OCB liquid crystal pixels that require the black insertion driving.

This invention is not limited to the above embodiment and can be variously modified without departing from the technical scope thereof.

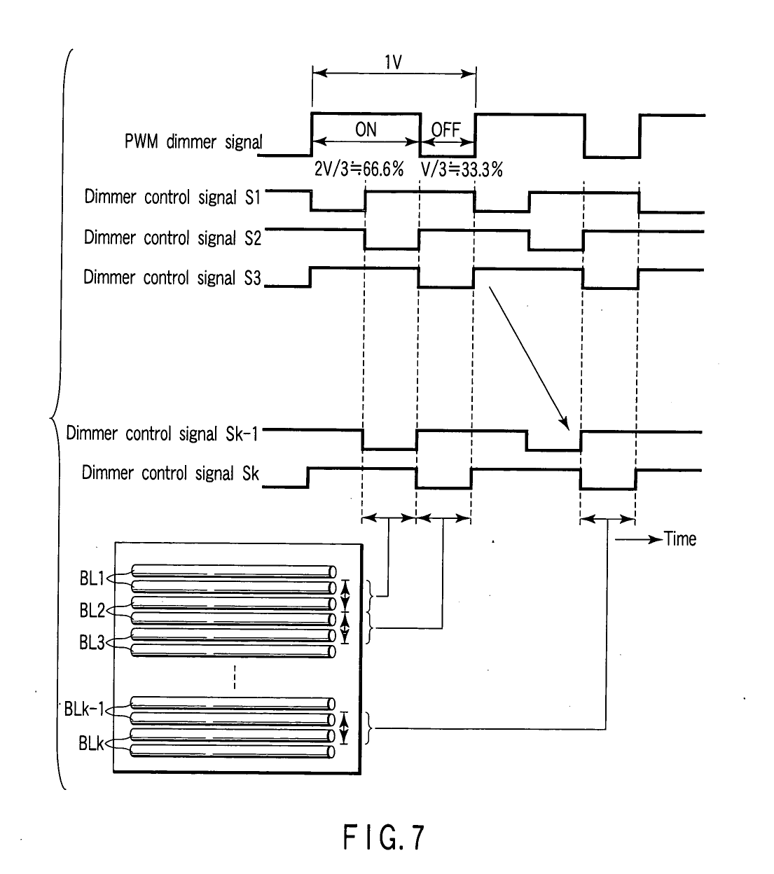

FIG. 7 shows one example of the operation when the number of lamp-type light sources of the backlight BL shown in FIG. 3 is increased. In this example, the backlight BL includes k lamp-type light sources BL1 to BLk which mainly illuminate k display areas obtained by equally dividing the display screen DS in the vertical direction. Further, each of the lamp-type light sources BL1 to BLk is configured by cold cathode fluorescent tubes, for example, two cold cathode fluorescent tubes. In this case, k driving units 11A, 11B, . . . and k phase controllers 13A, 13B, . . . of a backlight drive circuit LD are provided to correspond to the lamp-type light sources BL1 to BLk.

With the above configuration, since the duty ratios of the dimmer control signals S1 to Sk are equal, the average luminance levels of the lamp-type light sources BL1 to BLk are set to the same level. In addition, since the phases of the dimmer control signals S1 to Sk are different from one another, all of the lamp-type light sources can be prevented from being set to the ON state or OFF state except a case wherein the brightness of the display screen DS is set to 100% or 0%. Particularly, since an increase in the number of lamp-type light sources permits brightness to be changed for each of more finely divided display areas by the dimmer control, flicker can be made more non-prominent in comparison with the above embodiment. Further, since the numbers of driving units 11A, 11B, and phase controllers 13A, 13B, . . . are set equal to or less than half the number of cold cathode fluorescent tubes, the scale of the backlight drive circuit LD can be prevented from uselessly becoming large.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light source device comprising:
a plurality of lamp-type light sources which respectively illuminate display areas obtained by dividing a screen of a display panel; and
a light source driving circuit which drives said lamp-type light sources;
wherein said light source driving circuit includes a dimmer control circuit which generates dimmer control signals having a common duty ratio which is changed to define an ON time for each preset period of time, and being set to different phases, and a plurality of driving units which respectively drive said lamp-type light sources according to the dimmer control signals generated from said dimmer control circuit.

2. The light source device according to claim 1, wherein said dimmer control circuit includes a duty ratio detector which detects a duty ratio of a dimmer signal supplied externally and outputs a pulse width modulation signal of a duty ratio identical to the result of detection, and a plurality of phase controllers which change a phase of the pulse width modulation signal output from the duty ratio detector to attain the dimmer control signals.

3. The light source device according to claim 2, wherein said pulse width modulation signal has the same frequency as that of the dimmer signal.

4. The light source device according to claim 1, wherein different phase differences of the dimmer control signals are determined based on distances between said lamp-type light sources.

5. The light source device according to claim 2, wherein each of said driving units includes a voltage converter which converts the dimmer control signal from a corresponding one of said phase controllers to a drive voltage for a corresponding one of said lamp-type light sources.

6. The light source device according to claim 1, wherein each of said lamp-type light sources includes at least one cold cathode fluorescent tube.

7. The light source device according to claim 1, wherein the screen of said display panel includes a plurality of OCB liquid crystal pixels.

8. The light source device according to claim 2, wherein different phase differences of the dimmer control signals are determined based on distances between said lamp-type light sources.
